(19) United States
(12) Patent Application Publication
(10) Pub. No.: US 2024/0355129 A1
(43) Pub. Date: Oct. 24, 2024

(54) METHOD FOR CORRECTING LANE RECOGNITION INFORMATION USING ROAD TRAFFIC SIGN RECOGNITION INFORMATION, AND APPARATUS FOR PERFORMING THE METHOD

(71) Applicant: HL Klemove Corp., Incheon (KR)

(72) Inventors: Eunsan JO, Seoul (KR); Jun-Hyung CHA, Seongnam-si (KR)

(73) Assignee: HL Klemove Corp., Incheon (KR)

(21) Appl. No.: 18/380,009

(22) Filed: Oct. 13, 2023

(30) Foreign Application Priority Data
Apr. 24, 2023 (KR) 10-2023-0053076

(51) Int. Cl. G06V 20/56; B60W 40/072; B60W 50/14; G06V 20/58

(52) U.S. Cl. CPC G06V 20/588; B60W 40/072; B60W 50/14; G06V 20/582; B60W 2552/30; B60W 2552/53; B60W 2555/60; B60W 2556/10; B60W 2556/20

(57) ABSTRACT

A method for correcting lane recognition information using road traffic sign recognition information, and an apparatus for performing the method according to various exemplary embodiments of the present disclosure verify a validity of lane recognition information based on lane recognition information and independent road traffic sign recognition information, and correct the lane recognition information when the lane recognition information is information which is not valid, thereby enhancing lane recognition performance used for various advanced driver assistance systems (ADAS) functions.

### CROSS-REFERENCE TO RELATED APPLICATION

The present application claims the benefit of priority to Korean Patent Application No. 10-2023-0053076, filed on Apr. 24, 2023 in the Korean Intellectual Property Office, the entire content of which is incorporated herein by reference.

### TECHNICAL FIELD

The present disclosure relates to a method for correcting lane recognition information using road traffic sign recognition information, and an apparatus for performing the method, and more particularly, to a method and an apparatus for recognizing a lane.

### BACKGROUND

The need for lane recognition is increasing in various advanced driver assistance systems (ADAS) functions. For example, in functions such as lane departure warning (LDW), lane keeping assist (lane keeping assist), lane following assist (LFA), etc., geometry information of a lane has been used for determining a driving path of an ego-vehicle and generating a control path. Further, in functions such as adaptive cruise control (ACC), automated lane change (ALC), triggered lane change (TLC), etc., the geometry information of the lane has been used for determining the driving path of a surrounding vehicle and selecting a control target.

However, there is a problem in that a lot of noise is generated in lane recognition information for a distant location from the ego-vehicle. For example, a lane distant from a sensor becomes close to a camera vanishing point, so an error and noise are generated.

Accordingly, accuracy of the lane recognition information is required for previously determining/controlling the driving path by using front lane information.

The information disclosed in the Background section above is to aid in the understanding of the background of the present disclosure, and should not be taken as acknowledgement that this information forms any part of prior art.

### SUMMARY

In view of the above, various embodiments of the present disclosure provide a method for correcting lane recognition information using road traffic sign recognition information and an apparatus for performing the method, which include steps and functions of verifying a validity of lane recognition information based on lane recognition information and independent road traffic sign recognition information, and correcting the lane recognition information when the lane recognition information is not valid.

Other objects of the present disclosure, which are not explicitly described, may be additionally considered within the scope which can be easily deduced from the following detailed description and the effects thereof.

One exemplary embodiment of the present disclosure provides a method for correcting lane recognition information using road traffic sign recognition information, which includes: acquiring first road information based on the road traffic sign recognition information; acquiring second road information based on the lane recognition information; and correcting the lane recognition information based on the first road information and the second road information.

In the acquiring of the first road information, the first road information including a first curvature representing a design curvature of a road may be acquired based on the road traffic sign recognition information.

In the acquiring of the first road information, a speed limit corresponding to the road traffic sign recognition information may be acquired based on the road traffic sign recognition information, and the first curvature is acquired based on the acquired speed limit.

In the acquiring of the first road information, the first curvature corresponding to the speed limit may be acquired by using curvature design information to which the design curvature of the road is mapped for each design speed.

In the acquiring of the first road information, when a traffic sign corresponding to the road traffic sign recognition information is a speed limit sign in which a speed is directly described, a speed recognized from the speed limit sign may be acquired as the speed limit corresponding to the road traffic sign recognition information, and when the traffic sign corresponding to the road traffic sign recognition information is not the speed limit sign, the speed estimated from the speed limit sign may be acquired as the speed limit corresponding to the road traffic sign recognition information.

In the acquiring of the second road information, the second road information including a second curvature representing a curvature of a lane may be acquired based on the lane recognition information.

In the acquiring of the second road information, a lane polynomial may be acquired based on the lane recognition information, and the second curvature may be acquired based on the acquired lane polynomial.

In the acquiring of the second road information, when the lane recognition information is constituted by a plurality of lane points, the lane polynomial may be acquired based on the plurality of lane points.

The correcting of the lane recognition information may include verifying the validity of the lane recognition information based on the first road information and the second road information, and correcting the lane recognition information based on a validity verification result of the lane recognition information.

In the verifying of the validity, information on whether the lane recognition information is valid may be verified by comparing the first curvature of the first road information and the second curvature of the second road information.

In the verifying of the validity, when the second curvature is smaller than the first curvature, it is determined that the lane recognition information is the valid information, and when the second curvature is larger than the first curvature, it is determined that the lane recognition information is invalid information.

In the acquiring of the first road information, a first direction indicating a driving direction of the road may be acquired based on the road traffic sign recognition information, and the first road information including the first curvature and the first direction is acquired, and in the acquiring of the second road information, a second direction indicating a driving direction of the lane may be acquired based on the lane recognition information, and the second road information including the second curvature and the second direction is acquired, and in the verifying of the validity, the validity of the lane recognition information may be verified by comparing the first curvature of the first road information and the second curvature of the second road information, and comparing the first direction of the first road information and the second direction of the second road information.

In the verifying of the validity, when the second direction is the same as the first direction and the second curvature is smaller than the first curvature, it may be determined that the lane recognition information is the valid information, and when the second direction is not the same as the first direction or the second curvature is larger than the first curvature, it may be determined that the lane recognition information is invalid information.

In the correcting of the lane recognition information, when it is determined that the lane recognition information is the valid information, the lane recognition information may be maintained as it is, and when it is determined that the lane recognition information is invalid information, lane estimation information may be acquired based on past lane recognition information determined as the valid information in the past, and the lane recognition information may be corrected with the acquired lane estimation information.

In the correcting of the lane recognition information, when the number of times at which it is determined that the lane recognition information is invalid information is more than or equal to a predetermined reference number of times, a failure notification message may be output.

Another exemplary embodiment of the present disclosure provides an apparatus which includes: a memory storing one or more programs for correcting lane recognition information by using road traffic sign recognition information; and one or more processors performing an operation for correcting the lane recognition information by using the road traffic sign recognition information according to the one or more programs stored in the memory, in which the processor acquires first road information based on the road traffic sign recognition information, acquires second road information based on the lane recognition information, and corrects the lane recognition information based on the first road information and the second road information.

The processor may acquire the first road information including a first curvature representing a design curvature of a road based on the road traffic sign recognition information.

The processor may acquire the second road information including a second curvature representing a curvature of a lane based on the lane recognition information.

The processor may verify a validity of the lane recognition information based on the first road information and the second road information, and correct the lane recognition information based on a validity verification result of the lane recognition information.

The processor may verify whether the lane recognition information is valid information by comparing the first curvature of the first road information and the second curvature of the second road information.

By a method for correcting lane recognition information using road traffic sign recognition information, and an apparatus for performing the method according to various exemplary embodiments of the present disclosure, a validity of lane recognition information is verified based on lane recognition information and independent road traffic sign recognition information, and the lane recognition information is corrected when the lane recognition information is information which is not valid, thereby enhancing lane recognition performance used for various advanced driver assistance system (ADAS) functions.

Further, the validity of the lane recognition information is verified by using lane recognition and independent road traffic sign recognition to determine whether a lane recognition system has a failure.

The effects of the present disclosure are not limited to the aforementioned effect, and other effects, which are not mentioned above, will be apparent to a person having ordinary skill in the art and which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram for describing an apparatus according to an exemplary embodiment of the present disclosure.

FIG. 2 is a flowchart for describing a method for correcting lane recognition information using road traffic sign recognition information according to an exemplary embodiment of the present disclosure.

FIG. 3 is a diagram for describing a first road information acquiring step illustrated in FIG. 2.

FIG. 4 is a diagram illustrating an example of curvature design information illustrated in FIG. 3.

FIG. 5 is a diagram for describing a second road information acquiring step illustrated in FIG. 2.

FIG. 6 is a diagram for describing an example of a lane polynomial illustrated in FIG. 5.

FIG. 7 is a flowchart for describing a lane recognition information correcting step illustrated in FIG. 2.

FIG. 8 is a diagram for describing an example of a correction process of lane recognition information according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Hereinafter, embodiments of the present disclosure will be described in detail with reference to the accompanying drawings. Advantages and features of the present disclosure, and methods for accomplishing the same will be more clearly understood from embodiments described in detail below with reference to the accompanying drawings. However, the present disclosure is not limited to the embodiments set forth below, and may be embodied in various different forms. The present embodiments are just for rendering the disclosure of the present disclosure complete and are set forth to provide a complete understanding of the scope of the invention to a person with ordinary skill in the technical field to which the present disclosure pertains, and the present disclosure will only be defined by the scope of the claims. Throughout the whole specification, the same reference numerals denote the same elements.

Unless otherwise defined, all terms (including technical and scientific terms) used in the present disclosure may be used as the meaning which may be commonly understood by the person with ordinary skill in the art, to which the present disclosure pertains. Further, terms defined in commonly used dictionaries should not be interpreted in an idealized or excessive sense unless expressly and specifically defined.

In the present disclosure, the terms “first,” “second,”, and the like are used to differentiate a certain component from other components, but the scope of the invention should not be construed to be limited by the terms. For example, a first component may be referred to as a second component, and similarly, the second component may also be referred to as the first component.

In the present disclosure, in each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

In the present disclosure, expressions such as “have”, “can have”, “include” or “can include”, etc. express the presence of the corresponding features (e.g., components such as, numerical values, functions, operations, or elements), and the presence of an additional feature is not excluded.

Hereinafter, various exemplary embodiments of a method for correcting lane recognition information using road traffic sign recognition information, and an apparatus for performing the method according to the present disclosure will be described in detail with reference to the accompanying drawings.

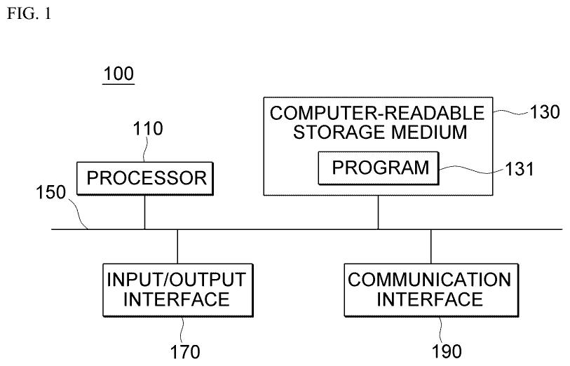

First, the apparatus according to an exemplary embodiment of the present disclosure will be described with reference to FIG. 1.

FIG. 1 is a block diagram for describing an apparatus according to an exemplary embodiment of the present disclosure.

Referring to FIG. 1, an apparatus 100 according to an exemplary embodiment of the present disclosure may verify a validity of lane recognition information based on lane recognition information and independent road traffic sign recognition information, and correct the lane recognition information when the lane recognition information is information which is not valid. As a result, according to the present disclosure, lane recognition performance used for various advanced driver assistance systems (ADAS) functions may be enhanced. For example, according to the present disclosure, trembling caused by noise may be reduced and stability may be enhanced when controlling lane keeping. Further, according to the present disclosure, in functions such as adaptive cruise control (ACC), automated lane change (ALC), triggered lane change (TLC), etc., the noise may be reduced at the time of selecting a control target.

Further, the apparatus 100 according to the present disclosure may verify the validity of the lane recognition information by using lane recognition and independent road traffic sign recognition. As a result, according to the present disclosure, it may be determined whether a lane recognition system has a failure.

To this end, the apparatus 100 may include one or more of a processor 110, a computer-readable storage medium 130, and a communication bus 150.

The processor 110 may be, for example, a computer, a microprocessor, a CPU, an ASIC, a circuitry, logic circuits, etc., and may control the apparatus 100 to operate. For example, the processor 110 may execute one or more programs 131 stored in the computer-readable storage medium 130. One or more programs 131 may include one or more computer-executable instructions, and when the computer-executable instructions are executed by the processor 110, the computer-executable instructions may be configured to allow the apparatus 100 to perform an operation for correcting the lane recognition information by using the road traffic sign recognition information.

The computer-readable storage medium 130 may be configured to store a computer-executable instruction or program code, program data, and/or other appropriate type of information for correcting the lane recognition information by using the road traffic sign recognition information. The program 131 stored in the computer-readable storage medium 130 includes a set of instructions executable by the processor 110. In an embodiment, the computer-readable storage medium 130 may be a memory (a volatile memory such as a random access memory, a non-volatile memory, or an appropriate combination thereof), one or more of magnetic disk storage devices, optical disk storage devices, flash memory devices, other types of storage medium accessed by the apparatus 100 and capable of storing desired information, or an appropriate combination thereof.

The communication bus 150 includes the processor 110 and the computer-readable storage medium 130 to interconnect various other components of the apparatus 100.

The apparatus 100 may include one or more input/output interfaces 170 and one or more communication interfaces 190 that provide interfaces for one or more input/output devices. The input/output interface 170 and the communication interface 190 are connected to the communication bus 150. An input/output device (not illustrated) mounted in a vehicle may be connected to other components of the apparatus 100 through the input/output interface 170. Meanwhile, the apparatus 100 according to the present disclosure is implemented as an independent separate module and mounted in the vehicle, and may perform a method for correcting the lane recognition information using the road traffic sign recognition information by receiving vehicle information from an electronic control unit (ECU) of the vehicle. Of course, according to the present disclosure, the method for correcting the lane recognition information using the road traffic sign recognition information may be implemented in the form of software and mounted in the vehicle, and the ECU of the vehicle may also perform the method for correcting the lane recognition information using the road traffic sign recognition information. In this case, the ECU of the vehicle may serve as the processor 110 of the apparatus 100 according to the present disclosure.

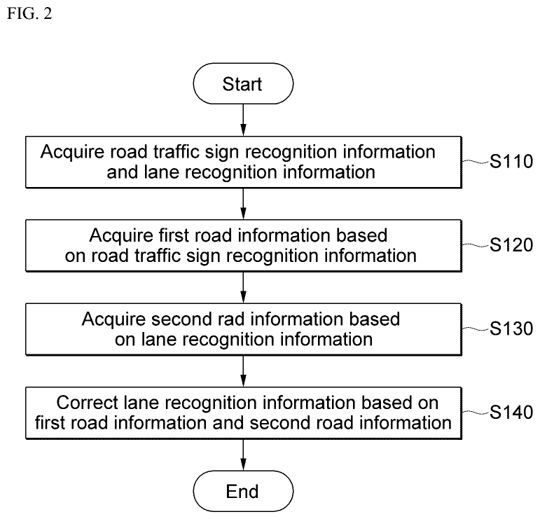

Then, the method for correcting lane recognition information using road traffic sign recognition information according to an exemplary embodiment of the present disclosure will be described with reference to FIGS. 2 to 6.

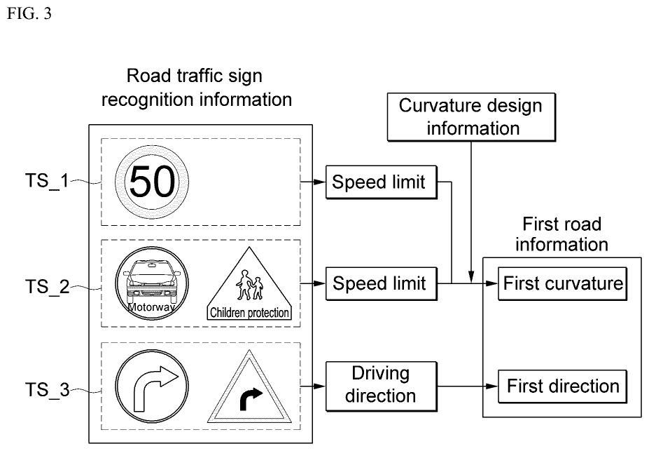

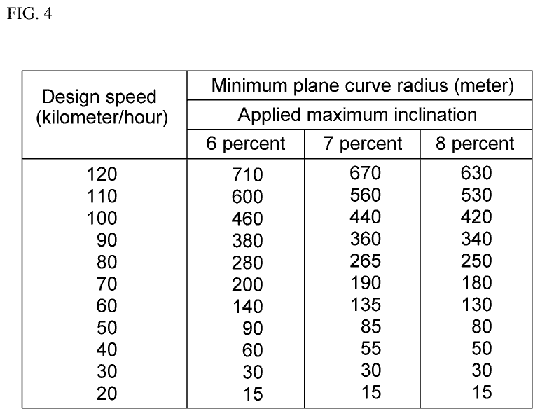

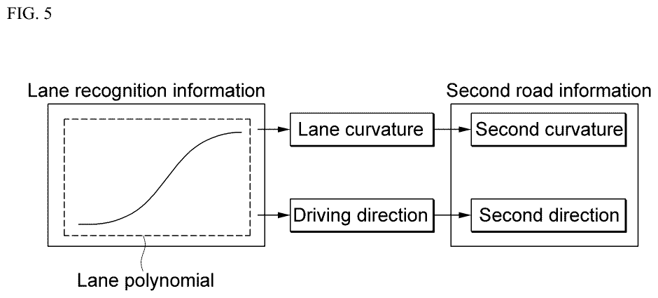

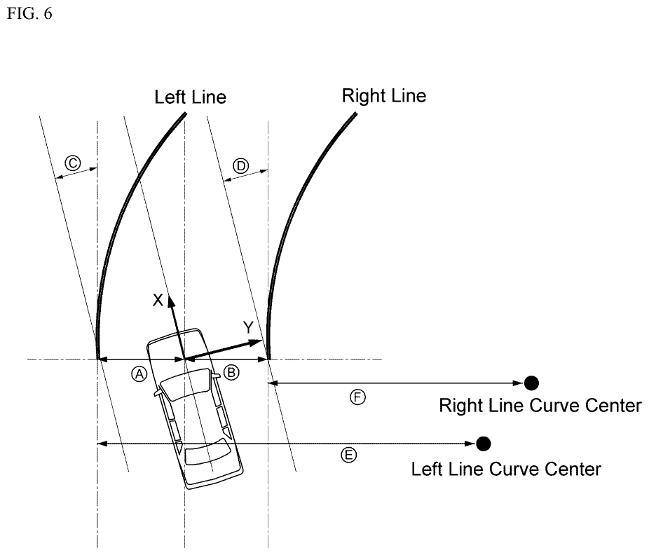

FIG. 2 is a flowchart for describing a method for correcting lane recognition information using road traffic sign recognition information according to an exemplary embodiment of the present disclosure, FIG. 3 is a diagram for describing a first road information acquiring step illustrated in FIG. 2, FIG. 4 is a diagram illustrating an example of curvature design information illustrated in FIG. 3, FIG. 5 is a diagram for describing a second road information acquiring step illustrated in FIG. 2, and FIG. 6 is a diagram for describing an example of a lane polynomial illustrated in FIG. 5.

Referring to FIG. 2, the processor 110 of the apparatus 100 may acquire road sign recognition information and lane recognition information (S110).

That is, the processor 110 may receive the road sign recognition information and the lane recognition information from an image sensor (not illustrated) mounted on a vehicle.

Here, the road sign recognition information refers to information on a traffic sign detected in a front image acquired through the image sensor. The lane recognition information refers to information on a lane detected in the front image acquired through the image sensor. For example, the lane recognition information may be acquired in the front image by using a conventionally known lane recognition algorithm. The lane recognition algorithm may convert an image into a bird eye view and generate a pixel type lane point (x,y), output the generated lane point (x,y) as it is, or curve fit and output the generated lane point in an n-degree polynomial (in general, 3-degree polynomial).

Of course, the processor 110 may receive the front image from the image sensor, and also acquire the road sign recognition information and the lane recognition information from the front image by using an image processing algorithm such as conventionally known object recognition algorithm, lane recognition algorithm, etc.

The processor 110 may acquire first road information based on the road traffic sign recognition information (S120).

That is, the processor 110 may acquire the first road information including a first curvature representing a design curvature of a road based on the road traffic sign recognition information.

When described in more detail with reference to FIG. 3, the processor 110 may acquire a speed limit corresponding to the road traffic sign recognition information based on the road traffic sign recognition information. In this case, when a traffic sign corresponding to the road traffic sign recognition information is a speed limit sign in which a speed is directly described, the processor 110 may acquire a speed recognized from the speed limit sign as the speed limit corresponding to the road traffic sign recognition information. For example, when the traffic sign is a speed limit sign such as a first traffic sign TS_1 illustrated in FIG. 3, the processor 110 may acquire “50 km/h” which is a speed recognized from the first traffic sign TS_1 as the speed limit. Further, when the traffic sign corresponding to the road traffic sign recognition information is not the speed limit sign, the processor 110 may acquire a speed estimated from the traffic sign as the speed limit corresponding to the road traffic sign recognition information. For example, when the traffic sign is a motorway sign or a child protection sign such as a second traffic sign TS_2 illustrated in FIG. 3, the processor 110 may acquire “90 km/h (motorway sign)/30 km/h (child protection sign)” which is a speed estimated from the second traffic sign TS_2 as the speed limit.

In addition, the processor 110 may acquire a first curvature based on the acquired speed limit. In this case, the processor 110 may acquire the first curvature corresponding to the speed limit by using curvature design information. Here, in respect to the curvature design information, a design curvature of the road may be mapped for each design speed of the road. For example, in the curvature design information, a minimum plane curve radius may be mapped for each design speed as illustrated in FIG. 4. That is, the processor 110 may acquire the minimum plane curve radius corresponding to the speed limit in the curvature design information, and acquire the first curvature corresponding to the speed limit based on the acquired minimum plane curve radius.

Here, the processor 110 may acquire a first direction indicating a driving direction of the road based on the road traffic sign recognition information, and also acquire first road information including the first curvature and the first direction.

That is, when a traffic sign corresponding to the road traffic sign recognition information is a direction sign indicating the driving direction of the road, the processor 110 may acquire the direction recognized from the direction sign as the driving direction corresponding to the road traffic sign recognition information. For example, when the traffic sign is a direction sign such as a third traffic sign TS_3 illustrated in FIG. 3, the processor 110 may acquire a “right direction’, which is a driving direction recognized from the third traffic sign TS_3, as the driving direction.

Then, the processor 110 may acquire second road information based on the lane recognition information (S130).

That is, the processor 110 may acquire second road information including a second curvature representing the curvature of the lane based on the lane recognition information.

When described in more detail with reference to FIG. 5, the processor 110 may acquire a lane polynomial based on the lane recognition information. For example, the recognized lane may be expressed by the 3-degree polynomial as illustrated in FIG. 6. In FIG. 6, \textcircled{a} represents a left line offset, \textcircled{b} represents a right line offset, \textcircled{c} represents a left line heading angle, \textcircled{d} represents a right line heading angle, \textcircled{e} represents a left line curvature and a curvature derivative, and \textcircled{f} represents a right line curvature and a curvature derivative. That is, a left line model may be expressed as in [Equation 1] below. In addition, a right line model may be expressed as in [Equation 2] below.

$$f ( x ) = C 0 L + C 1 Lx + C 2 {Lx}^{2} + C 3 {Lx}^{3} \qquad [ Equation 1 ]$$

Here, C0L represents the left line offset. C1L represents the left line heading angle. 2C2L represents the left line curvature. 6C3L represents a left line curvature derivative.

$$f ( x ) = + C 1 Rx + C 2 {Rx}^{2} + C 3 {Rx}^{3} \qquad [ Equation 2 ]$$

Here, C0R represents the right line offset. CIR represents the right line heading angle. 2C2R represents the right line curvature. 6C3R represents a right line curvature derivative.

In summary, by using such a line model, a location (offset) may be expressed as in [Equation 3] below, a heading angle may be acquired through [Equation 4] below, a curvature may be acquired through [Equation 5] below, and a curvature derivative may be acquired through [Equation 6] below. For example, when x is 0, the location (offset) becomes a (m), the heading angle becomes b (radian), the curvature becomes 2c (1/m), and the curvature derivative becomes 6d (1/m²).

$$f ( x ) = a + bx + {cx}^{2} + {dx}^{3} \qquad [ Equation 3 ]$$

$$f ' ( x ) = tan ( θ ) ≅ θ = b + 2 cx + 3 {dx}^{2} \qquad [ Equation 4 ]$$

$${f}^{′′} ( x ) = 2 c + 6 dx \qquad [ Equation 5 ]$$

$${f}^{′′′} ( x ) = 6 d \qquad [ Equation 6 ]$$

In this case, when the lane recognition information is constituted by a plurality of lane points, the processor 110 may acquire the lane polynomial based on the plurality of lane points. That is, the processor 110 curve-fits the plurality of lane points by the n-degree polynomial (in general, 3-degree polynomial) to acquire the lane polynomial.

In addition, the processor 110 may acquire the second curvature based on the acquired lane polynomial. That is, the processor 110 may acquire the second curvature corresponding to the recognized lane through [Equation 5] above.

Here, the processor 110 may acquire the second direction indicating the driving direction of the lane based on the lane recognition information, and also acquire second road information including the second curvature and the second direction.

That is, the processor 110 may acquire the second direction indicating the driving direction of the lane by using the lane polynomial acquired based on the lane recognition information.

More specifically, the processor 110 may acquire a curvature code of the lane based on the lane polynomial. That is, the processor 110 calculates a curvature corresponding to a predetermined location (front 100 m, i.e., x=100) based on [Equation 5] above to acquire a curvature code corresponding to the corresponding location. For example, when the lane according to the lane polynomial is a curve which is bent to the left, the curvature code becomes “+”. On the contrary, when the lane according to the lane polynomial is a curve which is bent to the right, the curvature code becomes “−”.

In addition, the processor 110 may acquire the second direction indicating the driving direction of the lane based on the curvature code of the lane. For example, when the curvature code of the lane is “+”, the processor 110 may acquire a “left direction” as the driving direction of the lane. On the contrary, when the curvature code of the lane is “−”, the processor 110 may acquire a “right direction” as the driving direction of the lane.

Thereafter, the processor 110 may correct the lane recognition information based on the first road information and the second road information (S140).

Meanwhile, it is illustrated in FIG. 2 that the second road information acquiring step (S130) is performed after performing the first road information acquiring step (S120), which is just one example, and in some embodiments, the second road information acquiring step (S130) may also be performed before performing the first road information acquiring step (S120) and also performed simultaneously with the first road information acquiring step (S120).

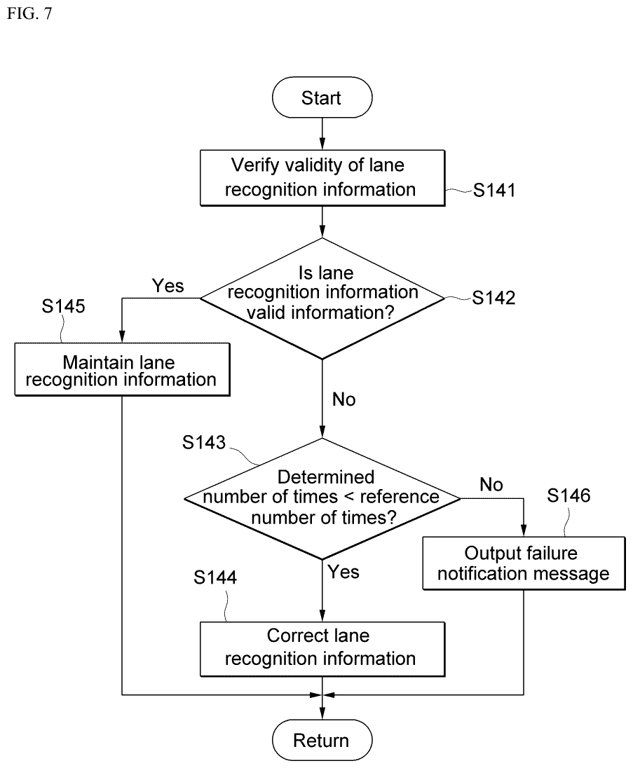

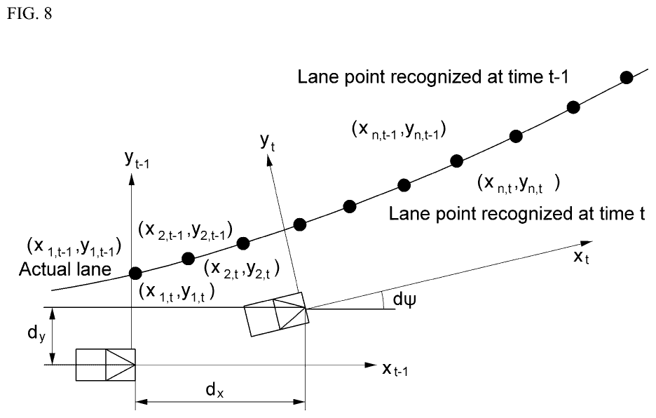

Then, a lane recognition information correcting step according to an exemplary embodiment of the present disclosure will be described in more detail with reference to FIGS. 7 and 8.

FIG. 7 is a flowchart for describing a lane recognition information correcting step illustrated in FIG. 2 and FIG. 8 is a diagram for describing an example of a process of correcting lane recognition information according to an exemplary embodiment of the present disclosure.

Referring to FIG. 7, the processor 110 of the apparatus 100 may verify the validity of the lane recognition information based on the first road information and the second road information (S141).

That is, the processor 110 may verify whether the lane recognition information is valid information by comparing the first curvature of the first road information and the second curvature of the second road information. More specifically, when an absolute value of the second curvature is smaller than the absolute value of the first curvature, the processor 110 may determine that the lane recognition information is the valid information. More specifically, when the absolute value of the second curvature is smaller than the absolute value of the first curvature, the processor 110 may determine that the lane recognition information is invalid information. For example, when the first curvature is “ 1/750” and the second curvature is “ 1/250”, the curvature according to the lane recognition information is larger than the curvature according to the road traffic sign recognition information, so the processor 110 may determine the lane recognition information as invalid information, i.e., noise.

In this case, when the first direction indicating the driving direction of the road is included in the first road information, the processor 110 may also verify the validity of the lane recognition information by comparing the first curvature of the first road information and the second curvature of the second road information, and comparing the first direction of the first road information and the second direction of the second road information. More specifically, when the second direction is the same as the first direction and the absolute value of the second curvature is smaller than the absolute value of the first curvature, the processor 110 may determine that the lane recognition information is the valid information. On the contrary, when the second direction is not the same as the first direction and the absolute value of the second curvature is larger than the absolute value of the first curvature, the processor 110 may determine that the lane recognition information is invalid information.

Then, the processor 110 may correct the lane recognition information based on a validity verification result of the lane recognition information.

That is, when determining that the lane recognition information is the valid information (S142-Y), the processor 110 may maintain the lane recognition information as it is (S145).

On the contrary, when determining that the lane recognition information is invalid information (S142-N), the processor 110 may correct the lane recognition information (S144). More specifically, the processor 110 may acquire lane estimation information based on past lane recognition information which is determined as the valid information in the past. In addition, the processor 110 may correct the lane recognition information with the acquired lane estimation information.

For example, when current lane recognition information is invalid information, the processor 110 may acquire the lane estimation information by estimating a current lane based on the past lane recognition information determined as the valid information in the past, as illustrated in FIG. 8. Lane points (x_{1,t-1},y_{1,t-1}), . . . , (x_{n,t-1},y_{n,t-1}) recognized at a previous time t-1 determined as the valid information in the past may be converted into vehicle coordinates at a current time t by using [Equation 7] below, by using a unit-time movement amount (dx, dy, dψ) of an ego-vehicle.

$$[ \begin{matrix}{x}_{n , t} \\ {x}_{n , t} \\ 1\end{matrix} ] = [ \begin{matrix}cos d ψ & sin d ψ & - ( dx sin d ψ + dy cos d ψ ) \\ - sin d ψ & cos d ψ & - ( - dx sin d ψ + dy cos d ψ ) \\ 0 & 0 & 1\end{matrix} ] [ \begin{matrix}{x}_{n , t - 1} \\ {x}_{n , t - 1} \\ 1\end{matrix} ] \qquad [ Equation 7 ]$$

More specifically, the lane recognition information may be corrected by estimating the current lane based on the past lane recognition information determined as the valid information in the past through three steps below by using a Bayesian estimation method.

### STEP 1: State Prediction

Lane points (x″_{1,t},y″_{1,t}), . . . , (x″_{n,t}, y″_{n,t}) to be observed at the current time t may be predicted by the lane points (x_{1,t-1},y_{1,t-1}), . . . , (x_{n,t-1},y_{n,t-1}) estimated at the previous time t-1. That is, the lane point to be observed at the current time t may be predicted through [Equation 7] above by using a distance and an angle dx, dy, and dψ at which the vehicle moves for the current time t from the previous time t-1 by using the lane point estimated at the previous time t-1. In addition, the uncertainty of the lane point estimated at the previous time t-1 may be updated as in [Equation 8] below by considering the uncertainty of a vehicle motion.

$${σ}_{n , t}^{{″}^{2}} = {σ}_{n , t - 1}^{{′}^{2}} + {σ}_{n , vehicle}^{2} \qquad [ Equation 8 ]$$

Here, σ″²_{n,t} represents the uncertainty of the lane point for the current time t. σ′²_{n,t-}1 represents the uncertainty of the lane point for the previous time t-1. θ′²_{n,vehicle} may represent the uncertainty of coordinate conversion of an n-th point due to the motion of the vehicle, and may be experientially set according to a vehicle speed, an angular speed, and a distance of a point.

### Step 2: Measurement Update

The lane point to be observed at the current time t may be estimated by using the lane polynomial observed at the current time t and the lane point predicted through step 1 (state prediction). That is, a lane point (x,y_{n,t}) may be derived by using the lane polynomial observed at the current time t based on an x coordinate of the predicted lane point. In addition, the uncertainty of the lane point observed at the current time t may be set by using a validity degree of lane recognition. That is, n-th pointer observation uncertainty o′²_{n,camera} may be set by an experiential method to be in proportion to a difference between the first curvature and the second curvature and to be in proportion to the distance of the vehicle point (as the distance increases, the uncertainty increases). In addition, the coordinate of the predicted point and the coordinate of the observed point may be corrected based on the uncertainty as in [Equation 9] below. In addition, the uncertainty of the predicted point and the uncertainty of the observed point may be updated as in [Equation 10] below.

$${x}_{n , t}^{′} = {x}_{n , t}^{″} \qquad [ Equation 9 ]$$

$${y}_{n , t}^{′} = \frac{{σ}_{n , camera}^{2} \times {y}_{n , t}^{″} + {σ}_{n , t}^{{″}^{2}} \times {y}_{n , t}}{{σ}_{n , t}^{{″}^{2}} + {σ}_{n , camera}^{2}}$$

Here, (x′_{n,t},y′_{n,t}) represents the lane point for the current time t corrected based on the uncertainty.

$${σ}_{n , t}^{{′}^{2}} = \frac{{σ}_{n , t}^{{″}^{2}} \times {σ}_{n , camera}^{2}}{{σ}_{n , t}^{{″}^{2}} + {σ}_{n , camera}^{2}} \qquad [ Equation 10 ]$$

### Step 3

The lane recognition information for the current time t may be corrected by fitting the estimated lane point (x′_{n,t},y′_{n,t}) by the lane polynomial. Such corrected lane recognition information may be applied to be used in various advanced driver assistance systems (ADAS) of the vehicle (e.g., lane departure warning (LDW), lane keeping assist (lane keeping assist), lane following assist (LFA), etc.).

In this case, when the number of times at which the lane recognition information is determined as the invalid information is more than or equal to a predetermined reference number of times (S143-N), the processor 110 may output a failure notification message (S146). That is, when the lane recognition information which is not valid is repeatedly acquired, a lane recognition system of the vehicle has the failure, so the processor 110 outputs the failure notification message through an output device mounted on the vehicle to notify the failure to a user.

The operations according to the embodiments are implemented in a form of a program command which may be performed through various computer means and may be recorded in the computer-readable storage medium. The computer-readable storage medium represents any medium that participates in providing instructions to a processor for execution. The computer-readable storage medium may include a program command, a data file, or a data structure or a combination thereof. For example, the computer-readable storage medium may include a magnetic medium, an optical recording medium, a memory, and the like. A computer program may be distributed on a networked computer system so that a computer readable code may be stored and executed in a distributed manner. Functional programs, codes, and code segments for implementing the embodiment may be easily inferred by programmers in the art to which the embodiment belongs.

The embodiments are for describing the technical spirit of the embodiment, and the scope of the technical spirit of the embodiment is not limited by the embodiment. The protection scope of the embodiment should be construed based on the following appended claims and it should be appreciated that the technical spirit included within the scope equivalent to the claims belongs to the embodiment.

What is claimed is:

1. A method for correcting lane recognition information using road traffic sign recognition information, the method comprising:
acquiring first road information based on the road traffic sign recognition information;
acquiring second road information based on the lane recognition information; and
correcting the lane recognition information based on the first road information and the second road information.

2. The method of claim 1, wherein in the acquiring of the first road information, the first road information including a first curvature representing a design curvature of a road is acquired based on the road traffic sign recognition information.

3. The method of claim 2, wherein in the acquiring of the first road information, a speed limit corresponding to the road traffic sign recognition information is acquired based on the road traffic sign recognition information, and the first curvature is acquired based on the acquired speed limit.

4. The method of claim 3, wherein in the acquiring of the first road information, the first curvature corresponding to the speed limit is acquired by using curvature design information to which the design curvature of the road is mapped for each design speed.

5. The method of claim 3, wherein in the acquiring of the first road information,
in response to a determination that a traffic sign corresponding to the road traffic sign recognition information is a speed limit sign in which a speed is directly described, a speed recognized from the speed limit sign is acquired as the speed limit corresponding to the road traffic sign recognition information, and
in response to a determination that the traffic sign corresponding to the road traffic sign recognition information is not the speed limit sign, the speed estimated from the speed limit sign is acquired as the speed limit corresponding to the road traffic sign recognition information.

6. The method of claim 2, wherein in the acquiring of the second road information, the second road information including a second curvature representing a curvature of a lane is acquired based on the lane recognition information.

7. The method of claim 6, wherein in the acquiring of the second road information, a lane polynomial is acquired based on the lane recognition information, and the second curvature is acquired based on the acquired lane polynomial.

8. The method of claim 7, wherein in the acquiring of the second road information, in response to a determination that the lane recognition information is constituted by a plurality of lane points, the lane polynomial is acquired based on the plurality of lane points.

9. The method of claim 6, wherein the correcting of the lane recognition information includes
verifying a validity of the lane recognition information based on the first road information and the second road information, and
correcting the lane recognition information based on a validity verification result in the verifying of the validity of the lane recognition information.

10. The method of claim 9, wherein in the verifying of the validity, information on whether the lane recognition information is valid is verified by comparing the first curvature of the first road information and the second curvature of the second road information.

11. The method of claim 10, wherein in the verifying of the validity, in response to a determination that the second curvature is smaller than the first curvature, it is determined that the lane recognition information is the valid information, and in response to a determination that the second curvature is larger than the first curvature, it is determined that the lane recognition information is invalid information.

12. The method of claim 10, wherein in the acquiring of the first road information, a first direction indicating a driving direction of the road is acquired based on the road traffic sign recognition information, and the first road information including the first curvature and the first direction is acquired,
in the acquiring of the second road information, a second direction indicating a driving direction of the lane is acquired based on the lane recognition information, and the second road information including the second curvature and the second direction is acquired, and
in the verifying of the validity, the validity of the lane recognition information is verified by comparing the first curvature of the first road information and the second curvature of the second road information, and comparing the first direction of the first road information and the second direction of the second road information.

13. The method of claim 12, wherein in the verifying of the validity, in response to a determination that the second direction is the same as the first direction and the second curvature is smaller than the first curvature, it is determined that the lane recognition information is valid, and in response to a determination that the second direction is not the same as the first direction or the second curvature is larger than the first curvature, it is determined that the lane recognition information is invalid information.

14. The method of claim 10, wherein in the correcting of the lane recognition information,
in response to a determination that that the lane recognition information is valid, the lane recognition information is maintained as it is, and
in response to a determination that that the lane recognition information is invalid information, lane estimation information is acquired based on past lane recognition information determined as the valid information in the past, and the lane recognition information is corrected with the acquired lane estimation information.

15. The method of claim 14, wherein in the correcting of the lane recognition information, in response to a determination that the number of times at which it is determined that the lane recognition information is invalid is more than or equal to a predetermined reference number of times, a failure notification message is output.

16. An apparatus comprising:
a memory storing one or more programs for correcting lane recognition information by using road traffic sign recognition information; and
one or more processors performing an operation for correcting the lane recognition information by using the road traffic sign recognition information according to the one or more programs stored in the memory,
wherein the processor is configured to:
acquire first road information based on the road traffic sign recognition information,
acquire second road information based on the lane recognition information, and
correct the lane recognition information based on the first road information and the second road information.

17. The apparatus of claim 16, wherein the processor acquires the first road information including a first curvature representing a design curvature of a road based on the road traffic sign recognition information.

18. The apparatus of claim 17, wherein the processor acquires the second road information including a second curvature representing a curvature of a lane based on the lane recognition information.

19. The apparatus of claim 18, wherein the processor
verifies a validity of the lane recognition information based on the first road information and the second road information, and
corrects the lane recognition information based on a validity verification result of the lane recognition information.

20. The apparatus of claim 19, wherein the processor verifies whether the lane recognition information is valid information by comparing the first curvature of the first road information and the second curvature of the second road information.
